(19) United States
(12) Patent Application Publication
(10) Pub. No.: US 2013/0173143 A1
(43) Pub. Date: Jul. 4, 2013

(54) MACHINE CONTROL SYSTEM HAVING DELAYED ENGINE START

(71) Applicant: Douglas Michael BIAGINI, Washington, IL (US)

(72) Inventor: Douglas Michael BIAGINI, Washington, IL (US)

(21) Appl. No.: 13/341,097

(22) Filed: Dec. 30, 2011

(51) Int. Cl. F02D 28/00; F02D 25/00

(52) U.S. Cl. 701/113

(57) ABSTRACT

A control system for a locomotive having at least a first engine and a second engine is provided. The control system may include a controller in communication with the first engine, the second engine, and a throttle. The controller may be configured to start the first engine when the throttle is moved from an idle position to a first position and determine if the locomotive is operating in a yard mode or a line-haul mode. The controller may also be configured to start the second engine if the locomotive is operating in the line-haul mode and the throttle is moved from the first position to a second position and delay start of the second engine if the locomotive is operating in the yard mode and the throttle is moved from the first position to the second position.

### TECHNICAL FIELD

The present disclosure relates generally to a machine control system, and more particularly, to a machine control system having a delayed engine start.

### BACKGROUND

Multi-engine machines, for example, “gen-set” locomotives are built with two or more separate engines. These “gen-set” locomotives can include identical engines or multiple engines of varying rated power output (e.g., a smaller engine and a larger engine). The locomotives are called “gen-set” locomotives because each engine is mounted together with an electric generator on a separate frame as an independent power pack, i.e., similar to a generator set used in backup power or remote power applications. The independent power packs are then mounted to a deck of a locomotive.

Today's multi-engine locomotives typically have two diesel engines, including a large primary engine and a small auxiliary engine. Either one or both engines may generate power to propel the locomotive. For example, at low throttle settings, only the small engine operates to provide power while the large engine is turned off. At intermediate throttle settings, only the large engine operates to provide power while the small engine is turned off. At the highest throttle setting, both engines operate to provide power to the locomotive.

Locomotives with multiple engines are often used in switch, yard, or light duty applications. During operation in these applications, a locomotive operator moves a throttle between different notch settings to cause the different engines to start and provide power to propel the locomotive. For example, the operator may initially move the throttle to a relatively high throttle notch to initiate movement of the locomotive and, once the locomotive starts to move, return the throttle notch to a lower notch. During this start sequence, the larger engine can be inadvertently caused to start when the throttle is moved to the high notch. However, the larger engine really never provides traction power because the throttle does not remain at the high throttle notch long enough for the large engine to provide power to the locomotive. As a result, fuel can be wasted during the unnecessary startup of the larger engine.

A system for improving fuel consumption of locomotives containing multiple engines is described in U.S. Pat. No. 7,431,005 (“the '005 patent”) of Hawkins et al. that issued on Oct. 7, 2008. The '005 patent describes a locomotive with a plurality of engines that operate simultaneously to drive the locomotive. When a first engine is operating and a second engine is off, a control system of the locomotive determines if a throttle notch position, a speed of the locomotive, and a power output of the first engine are all above threshold values for more than three seconds. If the conditions are met, only then is the second engine started. This delay in starting the second engine may help avoid unnecessary starting.

The system of the '005 patent may suffer fuel inefficiencies when operating in different applications. In particular, the '005 patent discloses only one mode of operating a multi-engine locomotive, and operates its engines in the same manner regardless of whether the locomotive is pulling freight over long distances or for moving rail cars in a yard application. Locomotives may have very different power requirements in the two aforementioned rail applications. Therefore, the lack of different control scenarios in the '005 patent can limit efficiency of the locomotive.

The control system and methods of the present disclosure solve one or more of the problems set forth above and/or other problems with existing technologies.

### SUMMARY OF THE INVENTION

In one aspect, the disclosure is directed to a control system for a locomotive having at least a first engine and a second engine. The control system may include a throttle movable by an operator between a plurality of positions to indicate a desired power output of the locomotive, the plurality of positions including an idle position, a first position corresponding to a greater power output than the idle position, and a second position corresponding to a greater power output than the first position. The control system may also include a controller in communication with the first engine, the second engine, and the throttle. The controller may be configured to start the first engine when the throttle is moved from the idle position to the first position and determine if the locomotive is operating in a yard mode or a line-haul mode. The controller may also be configured to start the second engine if the locomotive is operating in the line-haul mode and the throttle is moved from the first position to the second position and delay start of the second engine if the locomotive is operating in the yard mode and the throttle is moved from the first position to the second position.

In another aspect, the disclosure is directed toward a method of operating a locomotive. The method may include receiving a throttle position selection from an operator indicative of a desired power output of the locomotive and starting a first engine when the throttle position selection is a first position greater than an idle position. The method may also include determining if the locomotive is in a yard mode or a line-haul mode, starting a second engine when the throttle position selection is a second position greater than the first position and the locomotive is in the line-haul mode and delaying start of the second engine when the throttle position selection is the second position and the locomotive is in the yard mode.

### BRIEF DESCRIPTION OF THE DRAWINGS

FIG. 1 is an elevated side view illustration of an exemplary machine having a duel engine architecture;

FIG. 2 is a diagrammatic illustration of an exemplary disclosed control system utilized by the machine of FIG. 1;

FIG. 3 is a table illustrating an exemplary strategy for scheduling the power output of the machine of FIG. 1; and

FIG. 4 is a flowchart depicting an exemplary disclosed method performed by the control system of FIG. 2.

### DETAILED DESCRIPTION

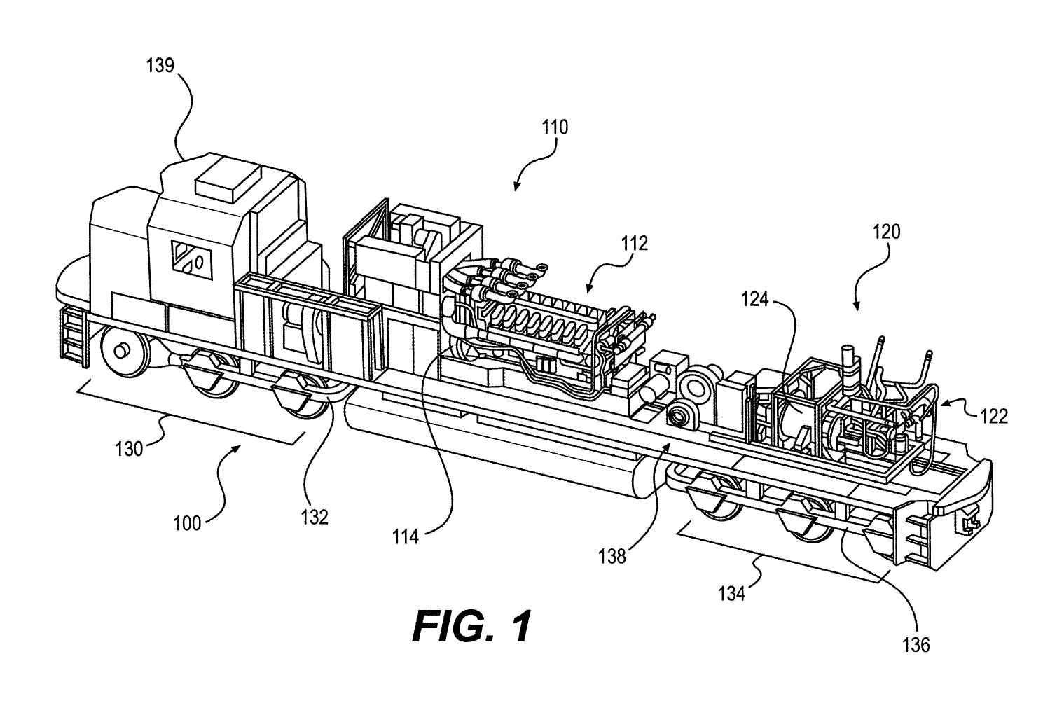

FIG. 1 depicts an exemplary machine 100. Machine 100 may be a locomotive and may have two separate and independent engine systems, including a large engine system 110 and a small engine system 120. Machine 100 may include a plurality of front wheels 130 attached to a front bogie frame 132, and a plurality of rear wheels 134 attached to a rear bogie frame 136. Wheels 130 and 134 may be configured to ride on and apply power to rails. Front bogie frame 132 and rear bogie frame 136 may support a base platform 138.

Large engine system 110 may include a large engine 112, for example an engine having sixteen cylinders and a rated power output of around 3,600 brake horsepower (bhp). It should be noted, however, that engines with other suitable number of cylinders or rated power output may alternatively be utilized. Large engine 112 may drive a traction generator 114 capable of outputting AC and/or DC electrical power. Large engine 112 may also drive a companion electrical generator (not shown), which may also be capable of outputting AC and/or DC electrical power. Large engine system 110 may include typical components and accessories for running large engine 112 and traction generator 114, including, but not limited to, a fuel injection system, an air cleaning and turbocharging system, a water jacket and/or separate circuit aftercooler cooling system, an air and/or electric starter, and an alternator excitation system, among others.

Small engine system 120 may include a small engine 122, for example an engine having six cylinders and a rated power output of approximately 700 bhp. It should be noted, however, that engines with other suitable number of cylinders or rated power output may alternatively be utilized. Small engine 122 may drive a traction generator 124 capable of outputting AC and/or DC electrical power, and a companion electrical generator (not shown), which may also be capable of outputting AC and/or DC electrical power. Small engine system 120 also may include typical components and accessories for running small engine 122 and traction generator 124, including, but not limited to, a fuel injection system, an air cleaning and turbocharging system, a water jacket and/or air-to-air aftercooler cooling system, an air and/or electrical starter, and an alternator excitation system, among others.

Large engine system 110 may be placed near a center of machine 100, generally between front and rear wheels 130, 134. Small engine system 120 may placed near a rear end of machine 100 opposite a cabin 139, and may generally be above rear wheels 134. Large engine 112 and small engine 122 may be diesel internal combustion engines. It should be noted, however, that one or both of large engine 112 and small engine 122 may be another type of internal combustion engine, such as a gasoline engine, a natural gas engine, a gas turbine engine, or other suitable engine.

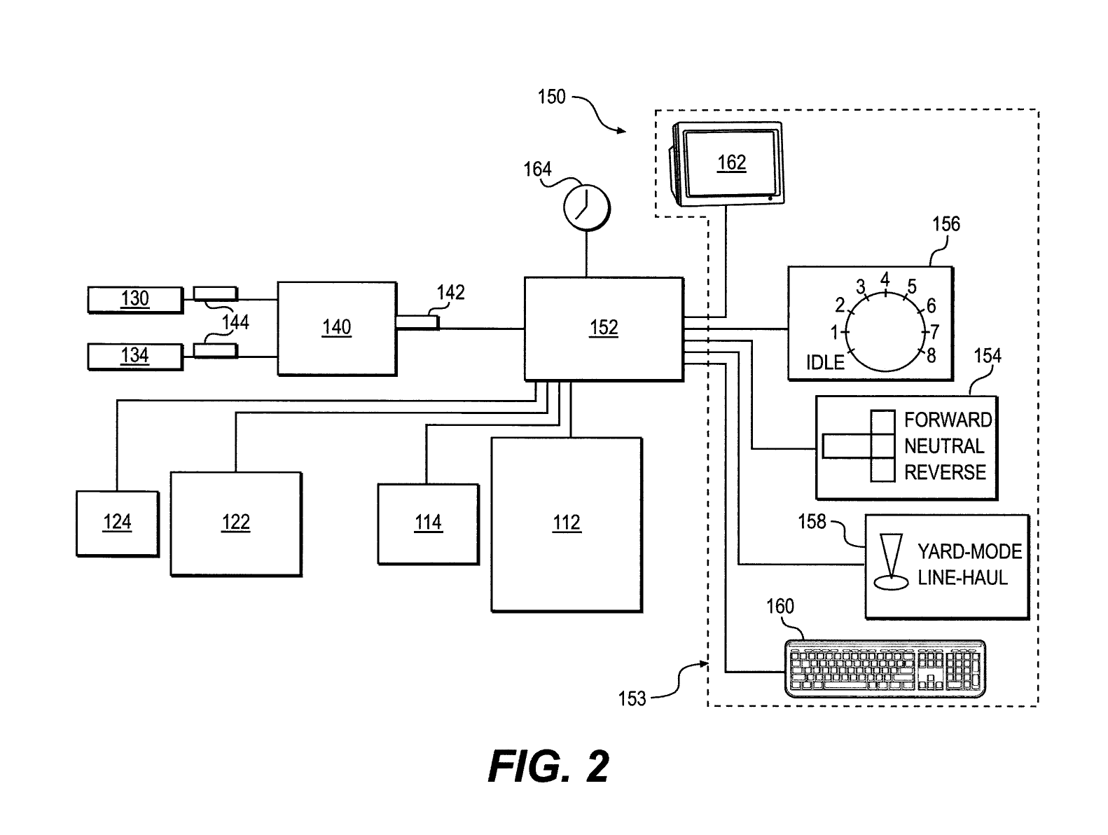

FIG. 2 illustrates an exemplary disclosed control system that may be used to control machine 100. The control system may include traction motors 140 powered by traction generators 114 and 124, and drivingly connected to wheels 130 and 134. Traction motors 140 may include any type of electrical motors. In some embodiments, traction motors 140 may be AC and/or DC motors. Traction motors 140 may be connected to an amperage sensor 142 configured to measure amperage of power consumed by one or more traction motors 140.

The control system may also include power system controls 150, which may include a controller 152 and an operator interface 153. Controller 152 may embody a single microprocessor or multiple microprocessors that include mechanisms for controlling an operation of machine 100. Numerous commercially available microprocessors can be configured to perform the functions of controller 152. It should be appreciated that controller 152 could readily embody a general machine system microprocessor capable of controlling numerous machine system functions and modes of operation. Various other known circuits may be associated with controller 152, including power supply circuitry, signal-conditioning circuitry, solenoid driver circuitry, communication circuitry, and other appropriate circuitry.

To facilitate effective control of the supply of electricity from traction generators 114 and 124 to traction motors 140, controller 152 may monitor various aspects of the generation of electricity by traction generators 114 and 124 and/or various aspects of the transmission of electricity within the system. For example, controller 152 may monitor the voltage, current, frequency, and/or phase of electricity generated by one or more of traction generators 114 and 124. Controller 152 may employ sensors and/or other suitable mechanisms to monitor such operating parameters. Controller 152 may also monitor various other aspects of the operation of machine 100 through various mechanisms such as amperage of power consumed by traction motors 140 via amperage sensor 142. Additionally, controller 152 may monitor the speed of machine 100 with a speed sensor(s) 144.

Operator interface 153 may include any component or components configured to transmit operator inputs to one or more components of machine 100. In some embodiments, operator interface 153 may include components that an operator can manipulate to indicate whether the operator desires propulsion of machine 100 by traction motors 140 and, if so, in what direction and with how much power the operator desires traction motors 140 to propel machine 100. For example, as FIG. 2 shows, operator interface 153 may include a reverser 154 and a throttle 156.

Reverser 154 may have an operating state designated “FORWARD,” which a user can select to indicate that the operator desires forward propulsion; an operating state designated “REVERSE,” which an operator can use to indicate that the operator desires backward propulsion; and an operating state designated “NEUTRAL,” which an operator can select to indicate that the operator does not desire propulsion of machine 100. Reverser 154 may indicate to one or more other components of power-system controls 150 which of the FORWARD, REVERSE, and NEUTRAL operating states the operator has selected. For example, reverser 154 may transmit a signal to controller 152 indicating which of these three operating states the operator has selected.

Throttle 156 may serve as a mechanism by which the operator can indicate how much power the operator desires traction motors 140 to employ to propel machine 100. Throttle 156 may be movable between a plurality of discrete positions that an operator can select to indicate a desired one of a plurality of discrete power levels. For example, as FIG. 2 shows, throttle 156 may have an “IDLE” position and positions 1-8. The IDLE position may correspond to the lowest desired power level for propulsion, and progressively higher numerical positions may correspond to progressively higher desired power levels for propulsion. In some embodiments, rather than a plurality of discrete positions, throttle 156 may have a continuous range of positions that an operator may select. Throttle 156 may communicate which position the operator has selected to one or more other components of power system controls 150. For example, throttle 156 may transmit a signal to controller 152 indicating the throttle position selected by the operator.

Operator interface 153 may also include a mode selector 158 that the operator may use to indicate which of a plurality of propulsion modes the operator desires. In some embodiments, for example where machine 100 is a locomotive, mode selector 158 may have a “LINE-HAUL” operating state for indicating that the operator desires a “line-haul” mode of operation and a “YARD” operating state for indicating that the operator desires a “yard” mode of operation. The line-haul mode of operation may be a mode of operation tailored for pulling railroad cars long distances. The yard mode of operation may be a mode of operation tailored for moving railroad cars within a rail yard. Mode selector 158 may communicate to one or more other components of power system controls 150 which mode of operation the operator has selected. For example, mode selector 158 may send a signal to controller 152 indicating whether the operator has selected line-haul mode or yard mode.

Operator interface 153 may also include an operator input device 160 with which an operator may input commands to be received by controller 152. Operator input device 160 may be a keyboard, touchpad, or other suitable mechanism for receiving operator input. One exemplary command that may be input into operator input device 160 is an override command. For example, operator input device 160 may send a signal to controller 152 indicating that machine 100 should remain in a yard mode of operation regardless of the position of mode selector 158.

A display 162 may be in communication with controller 152. Display 162 may be any known display mechanism and may visually output various information useful to an operator of machine 100. Additionally, display 162 may visually output the operating mode status of machine 100. For example, display 162 may output that machine 100 is operating in either yard mode or line-haul mode.

In one embodiment, a timer 164 may be associated with controller 152. In response to a command from controller 152, timer 164 may track an elapsed time associated with how long throttle 156 has been associated with a particular position. Signals indicative of this elapsed time may be directed from timer 164 to controller 152.

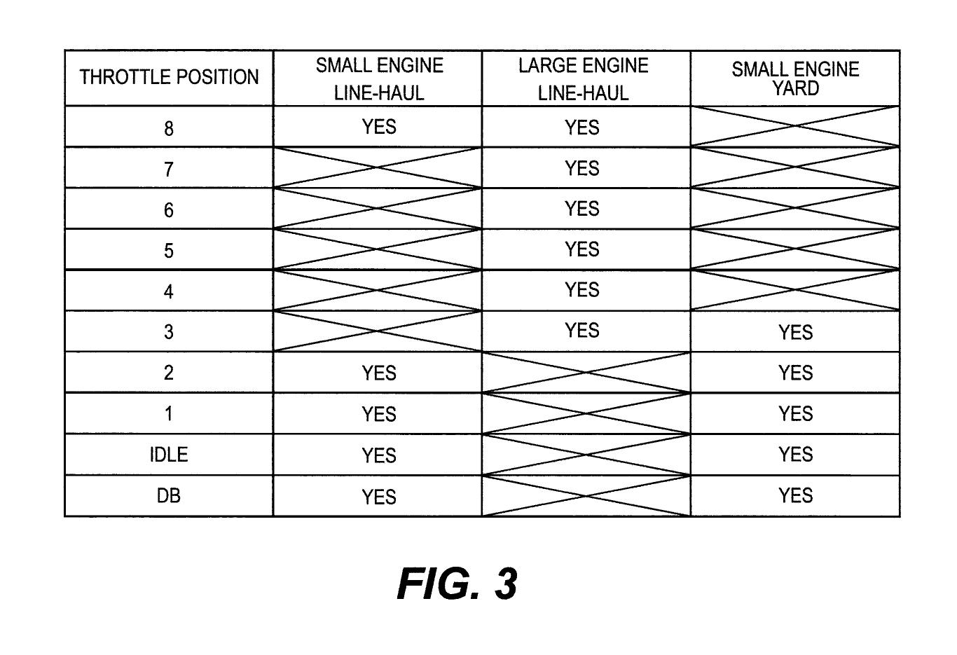

FIG. 3 illustrates how an exemplary machine control system may use large engine system 110, small engine system 120, or both, to fulfill power demands of machine 100. In lower power output conditions of line-haul mode, such as during idle, dynamic braking, and in positions 1 and 2, only small engine system 120 may be used. Controller 152 may regulate engine speed, fuel input, generator operation and other factors to produce the appropriate electrical power output from small engine system 120 in these conditions. In high power output conditions of line-haul mode, such as in positions 3 to 7, only large engine system 110 may be used. Likewise, controller 152 may regulate engine speed, fuel input, generator operation and other factors to produce the appropriate electrical power output from large engine system 110 in these conditions. In the highest power output condition(s) of line-haul mode, such as in position 8, both large engine system 110 and small engine system 120 may be used so that their combined power output can reach approximately 4,300 bhp to drive traction motors 140 in high acceleration or high speed line haul operation.

When throttle 156 is in idle position, position 1, or position 2, controller 152 may operate small engine 122 in the same manner in both yard mode and line-haul mode. However, the power requirements of machine 100 may differ when throttle 156 is in position 3, depending on the operating mode of machine 100. For example, in line-haul mode, when throttle 156 is moved to position 3, small engine 122 may be powered down and machine 100 may rely on only large engine 112 to provide traction power. Therefore, in line-haul mode, small engine 122 may encounter a line-haul operating threshold when throttle 156 is in position 2. The line haul operating threshold may be about 400 bhp, though other alternative thresholds may alternatively be used. However, when machine 100 is in yard mode and throttle 156 is in position 3, controller 152 may instead delay start of large engine 112 and increase a power output of small engine 122. The increased power output of small engine 122 may be about 95-100% of the rated power output of small engine 122. An exemplary increased power output of small engine system 120 may be greater than its line-haul operating threshold and may be up to about 670 bhp. It should be noted, however, that other suitable operating thresholds may alternatively be utilized. It should further be noted that the range of positions may vary and the determination of what engine to operate from a given position may also vary from the described exemplary embodiment.

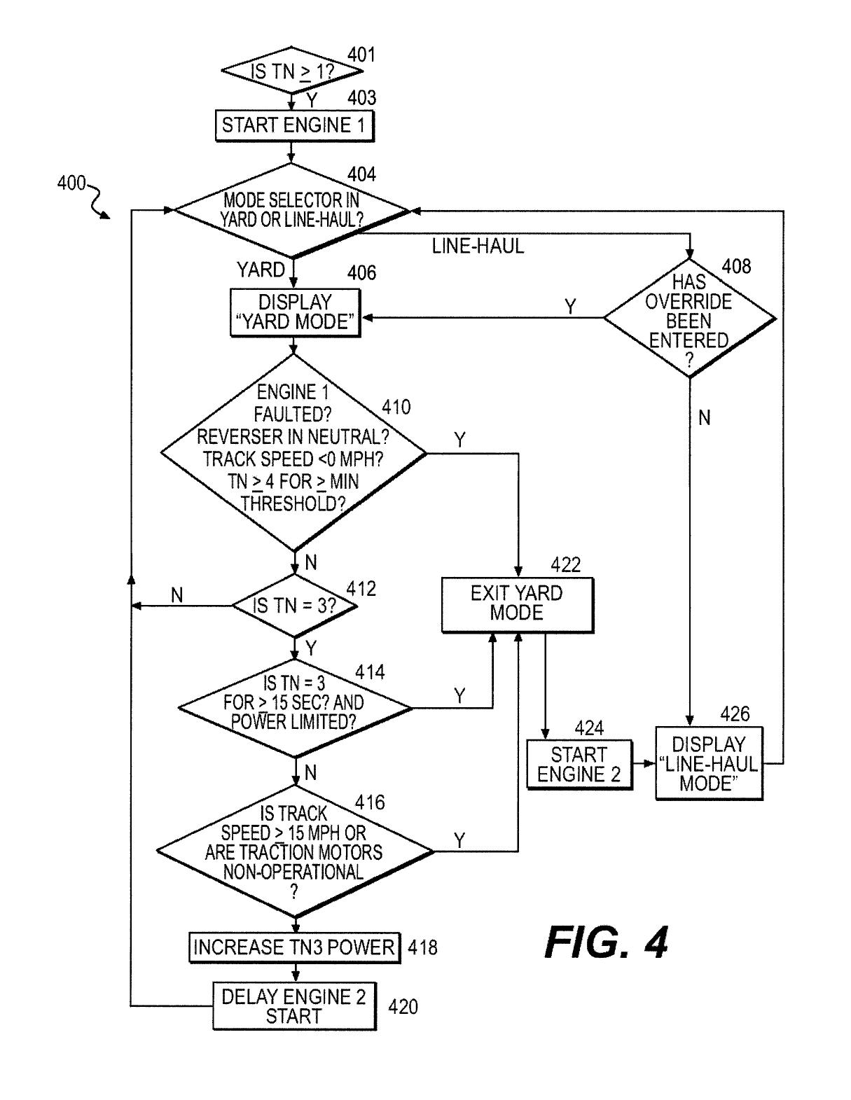

FIG. 4 illustrates an exemplary operation of machine 100 performed by the disclosed control system. FIG. 4 will be discussed in more detail below.

### INDUSTRIAL APPLICABILITY

The disclosed control system may be applicable to any machine operating in switch, light, or yard duty applications. A locomotive performing these applications may require significantly less power than a locomotive hauling freight over long distances. The disclosed control system may reduce fuel consumption by recognizing that these distinct applications require separate control strategies in order to be efficient. Specifically, while operating in yard duty applications, fuel costs and unnecessary wear on the larger engine can be avoided by delaying start of the larger engine based on operator and sensed inputs. An exemplary control process will now be described.

There is shown a flowchart 400 in FIG. 4 illustrating a machine control process according to an exemplary embodiment. Flowchart 400 may begin at Control Block 401, where controller 152 may determine if throttle 156 has been moved by an operator from an idle position to a position greater than or equal to 1 (it is noted that in the flowchart of FIG. 4, that ‘position’ is represented as ‘TN’). If throttle 156 has not been moved from an idle position to a position greater than or equal to 1, the process may remain at Control Block 401. If the position selection is greater than or equal to 1, small engine 122 may be started at Control Block 403 (unless small engine 122 is already in operation). From Control Block 403, the process may proceed to Control Block 404.

At Control Block 404, controller 152 may determine if mode selector 158 is in the “YARD” operating state position or the “LINE-HAUL” operating state position. If controller 152 determines that mode selector 158 is in the “YARD” operating state position, the process may proceed to Control Block 406. However, if controller 152 determines that mode selector 158 is in the “LINE-HAUL” operating state position, controller 152 may then determine if an override command has been entered via operator input device 160. If no override command has been entered at Control Block 408, the process may finish at Control Block 426 where controller 152 may cause display 162 to indicate to an operator that machine 100 is in line-haul mode.

When machine 100 has been preselected for yard duty applications, an authorized user of machine 100 may prevent an operator from manually disabling the yard mode of machine 100 by sending an override command to controller 152 via operator input device 160. Accordingly, upon receiving the override command signal from operator input device 160, controller 152 may determine at Control Block 404 that machine 100 is in yard mode regardless of the operating state position of mode selector 158 and the process may continue to Control Block 406. At Control Block 406, controller 152 may cause display 162 to indicate that machine 100 is in yard mode and then control may proceed to Control Block 410.

At Control Block 410, controller 152 may determine if engine system 120 has faulted, if reverser 154 is in the NEUTRAL position, if a track speed measured by speed sensor(s) 144 is less than 0 mph (i.e., if machine 100 is rolling backwards on an incline), and if throttle 156 is moved to a position greater than 4 for a minimum amount of time such as about 5 seconds. The minimum amount of time may alternatively be any other suitable time and may correspond to the length of a start alarm sent by controller 152. The start alarm may warn a crew of locomotive 100 that large engine 122 will start momentarily. If any of the conditions are true, the process may proceed to Control Block 422, where controller 152 may cause machine 100 to exit yard mode operation.

However, if none of the conditions of Control Block 410 are satisfied, machine 100 may remain in yard mode and the process may proceed to Control Block 412, where controller 152 may determine if throttle 156 has been moved to position 3. If throttle 156 has not been moved to position 3, the process may return to Control Block 401. However, if throttle 156 has been moved to position 3, the process may proceed to Control Block 414.

At Control Block 414, controller 152 may determine if throttle 156 has been moved to position 3 and maintained in position 3 for more than 15 seconds and if small engine 122 is power limited. A determination that small engine 122 is power limited may be made based upon a yard mode power map stored within the memory of controller 152. The yard mode power map may include a collection of data in the form of, for example, tables and/or equations. The yard mode power map may reference the sum of amperage output by traction motors 140 and the voltage of traction generator 124 driven by small engine 122. If both of the conditions of Control Block 414 are met, the process may proceed to Control Block 422 and controller 152 may exit yard mode. If these conditions are not met, however, the process may proceed to Control Block 416.

At Control Block 416, controller 152 may determine if machine 100 track speed measured by speed sensor(s) 144 exceeds a maximum threshold or if any traction motors 140 are non-operational. The maximum threshold speed, in one embodiment, may be about 15 mph. It should be noted, however, that other suitable track speeds may alternatively be utilized. If either condition is met, the process may proceed to Control Block 422 and controller 152 may exit yard mode. If neither condition is met, the process may proceed to Control Block 418.

At Control Block 418, the power output of small engine 122 may be increased. It is noted that the power output of small engine 122 may be increased beyond a line-haul operating power output of small engine 122 and may approach or exceed 100% of its rated power output. From Control Block 418, the process may proceed to Control Block 420 where large engine 112 may be delayed from starting. Start of large engine 112 may be delayed while machine 100 is in yard mode until conditions are met in any of Control Blocks 410, 414, or 416. Therefore, start of large engine 112 may be delayed until controller 152 determines that a yard mode has been disabled. If controller 152 determines that yard mode is disabled, the process may proceed from Control Block 422 to Control Block 424 where large engine 112 may be started. From Control Block 424, the process may finish at Control Block 426, where controller 152 may cause display 162 to indicate to an operator that machine 100 is in line-haul mode. Once the process reaches either Control Block 420 or Control Block 426, the process may repeat itself after about 500-1000 milliseconds, for example, to increase sensitivity and fuel efficiency of the process.

Machine 100 may operate at improved fuel efficiency in a switch, light, or yard duty applications by applying different control strategies depending on the operating mode of machine 100. The control strategies may also prevent wear of large engine 112 by preventing unnecessary starting of large engine 112. These advantages may be achieved by delaying the start of large engine 112, even when small engine 122 has a high output. That is, it may be more efficient to operate small engine 122 at a higher power output than to start large engine 112 for only short periods of time. Additionally, an override command may also be provided to prevent operators from circumventing the disclosed fuel efficient operating procedures. The override command may thus prevent operators from simply moving mode selector to the “LINE-HAUL” operating state position when machine 100 has been preselected for yard duty applications.

It will be apparent to those skilled in the art that various modifications and variations can be made to the disclosed control system without departing from the scope of the disclosure. Other embodiments of the control system will be apparent to those skilled in the art from consideration of the specification and practice of the control system disclosed herein. It is intended that the specification and examples be considered as exemplary only, with a true scope of the disclosure being indicated by the following claims and their equivalents.

What is claimed is:

1. A control system for a locomotive having at least a first engine and a second engine, comprising:
a throttle movable by an operator between a plurality of positions to indicate a desired power output of the locomotive, the plurality of positions including an idle position, a first position corresponding to a greater power output than the idle position, and a second position corresponding to a greater power output than the first position; and
a controller in communication with the first engine, the second engine, and the throttle, the controller being configured to:
start the first engine when the throttle is moved from the idle position to the first position;
determine if the locomotive is operating in a yard mode or a line-haul mode;
start the second engine if the locomotive is operating in the line-haul mode and the throttle is moved from the first position to the second position; and
delay start of the second engine if the locomotive is operating in the yard mode and the throttle is moved from the first position to the second position.

2. The control system of claim 1, wherein the second engine has a higher rated power output than the first engine.

3. The control system of claim 1, wherein the controller is further configured to exit the yard mode and enter the line-haul mode if the throttle is moved to a third position for a minimum amount of time, the third position corresponding to a greater power output than the second position.

4. The control system of claim 3, wherein the minimum amount of time is about 5 seconds.

5. The control system of claim 1, wherein the controller is configured to increase a power output of the first engine beyond a line-haul operating threshold when the locomotive is operating in the yard mode and the throttle is moved to the second position.

6. The control system of claim 5, wherein the power output of the first engine is increased to about 95-100% rated power output.

7. The control system of claim 1, wherein the controller is further configured to exit the yard mode, enter the line-haul mode, and start the second engine if a speed of the locomotive exceeds a maximum threshold after the throttle is moved to the second position.

8. The control system of claim 7 wherein the maximum threshold is about 15 mph.

9. The control system of claim 1, further including a mode selector in communication with the controller and movable between a yard mode operating state position and a line-haul mode operating state position, the controller further configured to determine a mode of the locomotive based on a position of the mode selector.

10. The control system of claim 9, further including an operator input device in communication with the controller, the controller further configured to receive an override command from the operator input device to maintain the locomotive in the yard mode regardless of the position of the mode selector.

11. A method of operating a locomotive, comprising:
receiving a throttle position selection from an operator indicative of a desired power output of the locomotive;
starting a first engine when the throttle position selection is at a first position greater than an idle position;
determining if the locomotive is in a yard mode or a line-haul mode;
starting a second engine when the throttle position selection is at a second position greater than the first position and the locomotive is in the line-haul mode;
delaying start of the second engine when the throttle position selection is at the second position and the locomotive is in the yard mode.

12. The method of claim 11, further including exiting the yard mode and entering the line-haul mode if the throttle position selection is at a third position for a minimum amount of time, the third position corresponding to a greater power output than the second position.

13. The method of claim 11, further including increasing a power output of the first engine beyond a line-haul operating threshold when the locomotive is operating in the yard mode and the throttle position selection is at the second position.

14. The method of claim 11, further including starting the second engine if a speed of the locomotive exceeds a maximum threshold after the throttle position selection is at the second position.

15. The method of claim 11, wherein determining if the locomotive is in the yard mode or the line-haul mode further includes receiving an input from the operator.

16. The method of claim 15, further including receiving an override command preventing the locomotive from exiting the yard mode.

17. A locomotive, comprising:
a base platform;
wheels that support the base platform;
a first engine mounted to the base platform and configured to drive the wheels;
a second engine mounted to the base platform and configured to drive the wheels, the second engine having a higher rated power output than the first engine;
a throttle movable by an operator between a plurality of discrete positions to indicate a desired power output of the locomotive, the plurality of discrete positions including an idle position, a first position corresponding to a greater power output than the idle position, and a second position corresponding to a greater power output than the first position; and
a controller in communication with the first engine, the second engine, and the throttle, the controller being configured to:
start the first engine when the throttle is moved from the idle position to the first position;
determine if the locomotive is operating in a yard mode or a line-haul mode;
start the second engine if the locomotive is operating in the line-haul mode and the throttle is moved from the first position to the second position; and
delay start of the second engine if the locomotive is operating in the yard mode and the throttle is moved from the first position to the second position.

18. The locomotive of claim 17, wherein the controller is further configured to exit the yard mode and enter the line-haul mode if the throttle is moved to a third position for a minimum amount of time, the third position corresponding to a greater power output than the second position.

19. The locomotive of claim 17, wherein the controller is configured to increase a power output of the first engine beyond a line-haul operating threshold when the locomotive is operating in the yard mode and the throttle is moved to the second position.

20. The locomotive of claim 17, wherein the controller is further configured to exit the yard mode, enter the line-haul mode, and start the second engine if a speed of the locomotive exceeds a maximum threshold after the throttle is moved to the second position.
